(19) United States
(12) Patent Application Publication
(10) Pub. No.: US 2006/0104643 A1
(43) Pub. Date: May 18, 2006

(54) Optical network for bi-directional wireless communication

(75) Inventors: Jae-Hoon Lee, Seoul (KR); Jeong-Seok Lee, Anyang-si (KR); Kwan-Soo Lee, Seoul (KR); Chang-Sup Shim, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/147,638

(22) Filed: Jun. 8, 2005

(30) Foreign Application Priority Data
Nov. 16, 2004 (KR) 2004-93497

(51) Int. Cl. H04B 10/00

(52) U.S. Cl. 398/115

(57) ABSTRACT

An optical network for bi-directional communication includes: a base station for generating downlink optical signals and detecting uplink optical signals; and a remote antenna unit for transmitting the downlink optical signals and generating the uplink optical signals to the base station; wherein the remote antenna includes: an optical detector for converting the downlink optical signals into downlink radio signals; an antenna for transmitting the downlink radio signals to outside thereof, and receiving the uplink radio signals in wireless communication; a semiconductor optical amplifier for converting the uplink radio signals into the uplink optical signals to output the uplink optical signals to the base station; and a circulating device having a plurality of ports, each of which is connected to the antenna, the optical detector, and the semiconductor optical amplifier, respectively.

### CLAIM OF PRIORITY

This application claims priority to an application entitled “OPTICAL NETWORK FOR BI-DIRECTIONAL WIRELESS COMMUNICATION,” filed in the Korean Intellectual Property Office on Nov. 16, 2004 and assigned Serial No. 2004-93497, the contents of which are hereby incorporated by reference.

### BACKGROUND OF THE INVENTION

1. Field of the Invention

The present invention relates to an optical network, and more particularly to a bi-directional optical network for relaying radio signals.

2. Description of the Related Art

A conventional optical network for transferring or relaying radio signals is referred to as Radio-of-Fiber (ROF). The type of networks transferring the ROF type signals includes both an optical communication network and a wireless network, or in combination thereof, which allows conversion of radio signals into optical signals transmissible through an optical fiber, etc.

The conventional optical network mentioned above includes a base station and a remote antenna unit linked to the base station. The base station outputs downlink optical signals and detects uplink signals. The remote antenna unit converts the downlink optical signals into downlink radio signals before transmitting the downlink radio signals over the air, and converts the received uplink radio signals into the uplink optical signals before outputting the uplink optical signals to the base station.

FIG. 1 illustrates a conventional optical network for relaying radio signals. As shown, the conventional optical network includes a base station 140 for generating the downlink optical signals and detecting the uplink optical signals, and a remote antenna unit 110 linked to the base station 140 through optical fibers.

The base station 140 includes an optical transmitter 120 for generating the downlink optical signals, and an optical receiver 130 for detecting data from the uplink optical signals that have been output by the remote antenna unit 110.

The remote antenna unit 110 includes an Electro-Absorption Modulator (EAM) 111 and an antenna 112. The EAM 111 converts the downlink optical signals to the downlink radio signals and outputs them to the antenna 112. The antenna 112 sends the downlink radio signals over the air, receives the uplink radio signals from the outside, and outputs the received radio signals to the EAM 111.

The EAM 111 converts the uplink radio signals into the uplink optical signals and outputs the converted signals to the base station 140. The EAM 111 functions as an optical receiver in the uplink and as an optical transmitter in the downlink.

FIG. 2 illustrates another conventional optical network 200 for relaying radio signals. As shown, the conventional optical network 200 includes a base station 240 for generating the downlink optical signals and detecting the uplink optical signals, and a remote antenna unit linked to the base station 240 through the first and the second optical fibers.

The base station 240 includes an optical transmitter 220 for generating the downlink optical signals and an optical receiver 230 for detecting data from the uplink optical signals that have been output by a remote antenna unit 210.

The remote antenna unit 210 includes an Electro-Absorption Modulator (EAM) 212, an antenna 211, and a semiconductor optical amplifier 213. The antenna 211 transmits the downlink radio signals to outside, receives the uplink radio signals from the outside, and outputs the received uplink radio signals to EAM 212.

The EAM 212 converts the downlink optical signals into the downlink radio signals and outputs them to the antenna 211. Then, the antenna 211 transmits the downlink radio signals to the outside thereof. Also, the antenna 211 receives the uplink radio signals from the outside thereof, converts the received uplink radio signals into uplink optical signals, and outputs the uplink optical signals to a semiconductor optical amplifier (SOA) 213. The EAM 212 connected between the antenna 211 and the SOA 213 not only convert the uplink radio signals into the uplink optical signals but also convert the downlink optical signals into the downlink radio signals.

The SOA 213 of the remote antenna unit 210 amplifies the uplink optical signals obtained through the conversion by the EAM 212 and outputs the amplified uplink optical signals to the base station 240.

As described above, the Electro-Absorb Modulator or EAM of the prior art has functions for converting both the optical signals into the electric signals and the electric signals into the optical signals. In the conversion from the electric signals to the optical signals, however, the EAM has a problem in that the receiving efficiency tends to suffer as the conventional EAM handles or processes both the uplink and the downlink optical signals. Further, it is very difficult to obtain a sufficient power margin for the signals, especially in the uplink.

### SUMMARY OF THE INVENTION

Accordingly, the present invention has been made to solve the above-mentioned problems occurring in the prior art and provides additional advantages, by providing an optical network including a remote antenna, wherein power loss especially, in the uplink of optical network, can be significantly lowered to ensure a sufficient power margin for the signals.

In one embodiment, there is provided an optical network for bi-directional communication, the optical network comprising: a base station for generating downlink optical signals and detecting uplink optical signals; and a remote antenna unit for transmitting the downlink optical signals, converting uplink radio signals into the uplink optical signals to output the uplink optical signals to the base station. The remote antenna further includes: an optical detector for converting the downlink optical signals into downlink radio signals; an antenna for transmitting the downlink radio signals to outside thereof and receiving the uplink radio signals in wireless communication; a semiconductor optical amplifier for converting the uplink radio signals into the uplink optical signals to output the uplink optical signals to the base station; and a circulating device having a plurality of ports, each of which is connected to the antenna, the optical detector. and the semiconductor optical amplifier, respectively.

### BRIEF DESCRIPTION OF THE DRAWINGS

The above features and advantages of the present invention will be more apparent from the following detailed description taken in conjunction with the accompanying drawings, in which:

FIG. 1 is a schematic diagram illustrating an optical network for relaying radio signals according to a prior art;

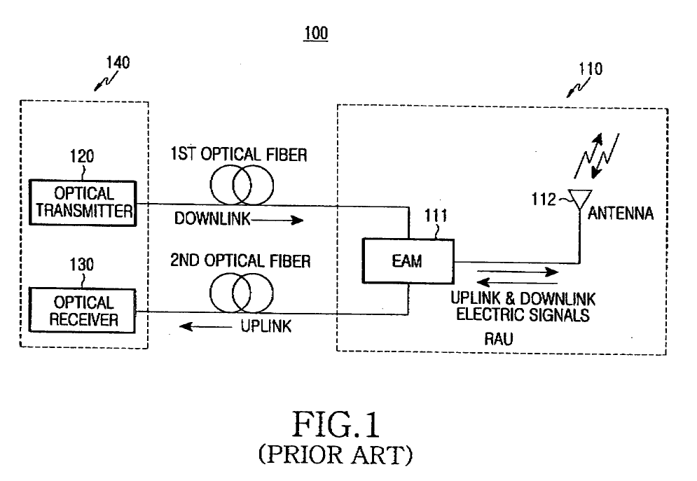

FIG. 2 is a schematic diagram illustrating another optical network for relaying radio signals according to a prior art; and

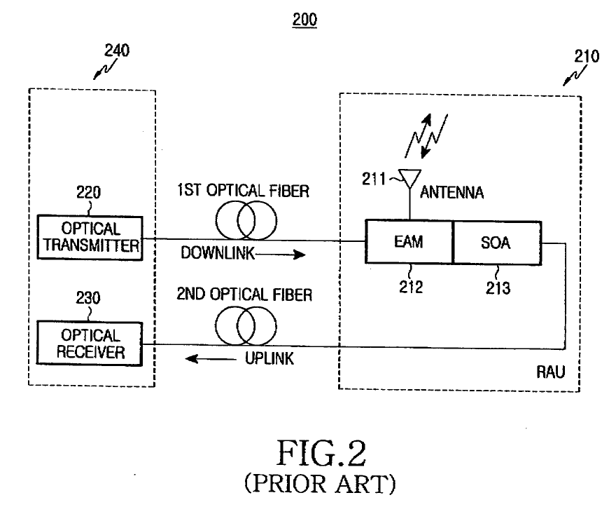

FIG. 3 is a schematic diagram illustrating an optical network for bi-directional relay of radio signals according to one embodiment of the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

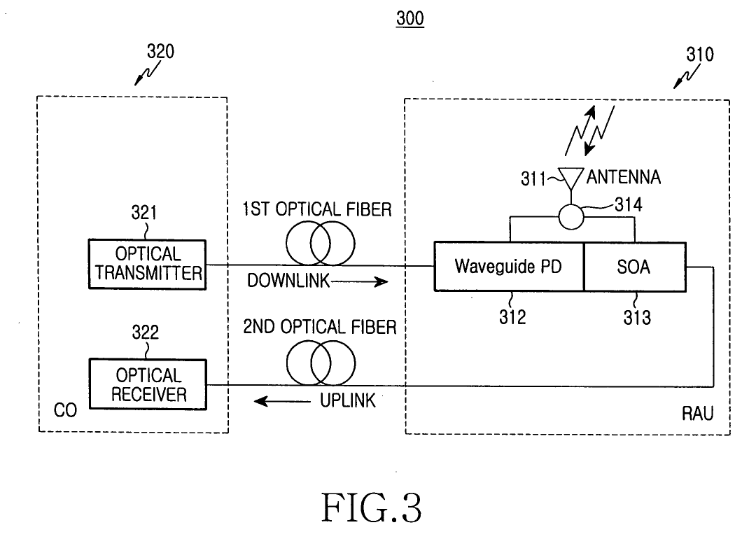

FIG. 3 illustrates a bi-directional optical network for relaying radio signals according to one embodiment of the present invention. As shown, the optical network 300 according to the present invention includes a base station 320 for generating downlink optical signals and detecting uplink optical signals, and a remote antenna unit 310 for transmitting the downlink radio signals over the air and receiving uplink radio signals from the outside of the unit 310. The remote antenna unit 310 converts the received uplink radio signals into the uplink optical signals and outputs the uplink optical signals to the base station 320. The optical network 300 further includes first and second optical fibers for linking the base station 320 with the remote antenna unit 310.

The base station 320 has an optical transmitter 321 for generating the downlink optical signals and an optical receiver 322 for detecting the uplink optical signals. The optical transmitter 321 is linked with the remote antenna unit 310 via the first optical fibers and the optical receiver 322 is linked with the remote antenna unit 310 via the second optical fibers.

The base station 320 generates downlink radio signals that are high frequency signals using electric signals that have been previously modulated. The base station 320 also serves to provide wireless communication services. Thus, the optical transmitter 321 of the base station 320 converts the generated downlink radio signals of the high frequency into the downlink optical signals.

The downlink optical signals obtained through a conversion process in the optical transmitter 321 are transmitted to the remote antenna unit 310 through the first optical fibers, whereas the uplink optical signals are transmitted from the remote antenna unit 310 to the base station 320 through the second optical fibers.

The remote antenna unit 310 includes an optical detector 312 for converting the downlink optical signals into the downlink radio signals. Also, the remote antenna unit 301 further includes an antenna 311, a semiconductor optical amplifier (SOA) 313, and a circulating means 314 having first to third ports.

The optical detector 312 is coupled to the base station 320 through the first fiber, receives the downlink optical signals through the first optical fibers, converts the received downlink optical signals into the downlink radio signals, and outputs the downlink radio signals to the antenna 311. The optical detector 312 includes, for example, a photo diode in the form of a planar waveguide, or a traveling-waveguide photodiode.

The antenna 311 transmits the downlink radio signals over the air. The antenna 311 also receives the uplink radio signals from the outside thereof and outputs the received uplink radio signals to the semiconductor optical amplifier 313.

The semiconductor optical amplifier 313 is coupled to the optical receiver 322 through the second optical fiber, converts the uplink radio signals into the uplink optical signals, and outputs the uplink optical signals to the base station 320.

The circulating device 314 receives the uplink radio signals through a first port connected to the antenna 311, and outputs the received radio signals to a second port connected to the semiconductor optical amplifier 313. Also, the circulating device 314 receives the downlink radio signals through a third port connected to the optical detector 312, and output the received downlink radio signals to the first port. The circulating device 314 includes, for example, a circulator or an ultra high frequency combiner.

The remote antenna unit 310 has therein RF devices which may be capable of sending radio signals over wireless transmissions. The RF devices may generate the uplink radio signals which are input to the semiconductor optical amplifier 313 through the antenna 311.

According to the present invention, the remote antenna unit 310 may employ one of an FDD (Frequency Division Duplex) scheme and a TDD (Time Division Duplex) scheme. The FDD scheme is a scheme in which the antenna unit uses different frequencies for uplink and downlink radio signals, whereas the TDD scheme is a scheme in which the antenna unit uses the same frequency which, however, can be distinguished in respect of time periods for both uplink radio signals and downlink radio signals.

According to the FDD scheme, in converting the downlink optical signals (converted from the downlink radio signals) into the uplink optical signals, only the uplink optical signals can be extracted from mixture of the uplink optical signals and the downlink optical signals by an additional electric filter in the base station.

According to the TDD scheme, since the uplink radio signals and the downlink radio signals are transmitted separately in different time periods, the uplink radio signals can be easily detected when they are converted into the uplink optical signals in the semiconductor optical amplifier.

The uplink radio signals having been received through the antenna 311 can be amplified or deformed if necessary, by a variety of electric devices such as an electric amplifier, before the uplink radio signals reach the semiconductor optical amplifier 313.

The optical detector 312 may be, for example, a photodiode in the form of a planar waveguide, with which the semiconductor optical amplifier 313 can be integrated together on single chip or substrate.

After converted from the uplink radio signals in the remote antenna unit 310, the uplink optical signals are amplified in the semiconductor optical amplifier 313 and then transmitted to the base station 320. Accordingly, the uplink also can secure a sufficient margin of power.

After the uplink optical signals are deformed into electric signals in the optical receiver 322, only desired or necessary signals are derived from the deformed electric signals through the electric filter. Thereafter, the derived signals go through a down conversion in a mixer so that a desired data can be extracted from the down-converted signals.

In the optical network for wireless communication according to the embodiment of the present invention as mentioned above, since the remote antenna unit 310 includes the optical detector 312 which has a photo diode for functioning as optical receiver of the downlink optical signals, and the semiconductor optical amplifier 313 which functions as both an optical transmitter and an optical amplifier of the uplink optical signals, the uplink optical signals and the downlink optical signals can be processed separately to secure the power margin of the optical signals in the up link of the optical network.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical network for bidirectional communication, comprising:
a base station for generating downlink optical signals and detecting uplink optical signals; and
a remote antenna unit for transmitting the downlink optical signals, converting uplink radio signals, into the uplink optical signals to output the uplink optical signals to the base station;
wherein the remote antenna comprises:
an optical detector for converting the downlink optical signals into downlink radio signals;
an antenna for transmitting the downlink radio signals to outside thereof and receiving the uplink radio signals;
a semiconductor optical amplifier for converting the uplink radio signals into the uplink optical signals to output the uplink optical signals to the base station; and
a circulating device having a plurality of ports, each of which is connected to the antenna, the optical detector, and the semiconductor optical amplifier, respectively.

2. The optical network as claimed in claim 1, wherein the circulating device further comprises a circulator in which the uplink radio signals pass through a first port through the antenna and then pass through a second port connected to the semiconductor optical amplifier, and the downlink radio signals pass through a third port through the optical detector and then output to the first port.

3. The optical network as claimed in claim 2, wherein the circulating device comprises an ultra-high frequency combiner.

4. The optical network as claimed in claim 1, wherein the optical detector comprises a photodiode in the form of an optical waveguide.

5. The optical network as claimed in claim 1, wherein the optical detector comprises a traveling waveguide photodiode.

6. The optical network as claimed in claim 1, wherein the remote antenna unit employs one of an FDD (Frequency Division Duplex) scheme and a TDD (Time Division Duplex) scheme.

7. The optical network as claimed in claim 1, wherein the optical detector comprises a photodiode in the form of a planar waveguide, with which the semiconductor optical amplifier can be integrated into a single chip or substrate.

8. The optical network as claimed in claim 1, wherein the base station comprises an optical transmitter for generating the downlink optical signals and an optical receiver detecting the uplink optical signals.

9. The optical network as claimed in claim 8, further comprising a filter for selectively deriving signals form the uplink optical signals.
